(19) United States
(12) Patent Application Publication
(10) Pub. No.: US 2025/0112299 A1
(43) Pub. Date: Apr. 3, 2025

(54) BATTERY PACK

(71) Applicant: TOYOTA JIDOSHA KABUSHIKI KAISHA, Toyota-shi (JP)

(72) Inventor: Yuya TAKAHASHI, Mishima-shi (JP)

(73) Assignee: TOYOTA JIDOSHA KABUSHIKI KAISHA, Toyota-shi (JP)

(21) Appl. No.: 18/661,896

(22) Filed: May 13, 2024

(30) Foreign Application Priority Data
Sep. 28, 2023 (JP) 2023-168788

(51) Int. Cl. H01M 50/102; G01M 3/04; H01M 50/148; H01M 50/242

(52) U.S. Cl. CPC H01M 50/102; G01M 3/045; H01M 50/148; H01M 50/242

(57) ABSTRACT

A battery pack of the present disclosure includes a lower case and an upper case, wherein the lower case and the upper case face each other in a first direction, and the lower case and the upper case have a joining portion joining the lower case and the upper case, and the joining portion is positioned so as to overlap the energy storage device when viewed from a second direction perpendicular to the first direction, and the lower case has a partition wall disposed so as to surround the periphery of the energy storage device, the partition wall protrudes beyond the joint toward the upper case in the first direction, and the filling member is filled between the partition wall and the energy storage device up to the upper case side in the first direction from the joining portion.

### CROSS-REFERENCE TO RELATED APPLICATION

This application claims priority to Japanese Patent Application No. 2023-168788 filed on Sep. 28, 2023, incorporated herein by reference in its entirety.

### BACKGROUND

### 1. Technical Field

The present disclosure relates to battery packs.

### 2. Description of Related Art

Japanese Unexamined Patent Application Publication No. 2018-081820 (JP 2018-081820 A) discloses a battery module including a side restricting portion that reduces horizontal displacement of battery cells.

### SUMMARY

In a battery pack including a lower case and an upper case and housing an energy storage device, a side restricting portion is sometimes formed by solidifying a liquid filling member in order to place the side restricting portion with no gap left between the energy storage device and the lower case. In this case, the battery pack can be filled with the filling member only to the position of the joint between the lower case and the upper case.

The present disclosure was made in view of the above problem, and an object of the present disclosure is to provide a battery pack that can be filled with a filling member for restricting lateral displacement of an energy storage device to a position higher than the position of the joint between a lower case and an upper case.

In order to solve the above problem and achieve the above object, a battery pack according to the present disclosure is a battery pack including a lower case and an upper case and housing an energy storage device. The battery pack is characterized in that the lower case and the upper case face each other in a first direction,
the lower case and the upper case include a joint where the lower case and the upper case are joined together,
the joint is located so as to overlap the energy storage device as viewed in a second direction perpendicular to the first direction,
the lower case includes a partition wall,
the partition wall protrudes beyond the joint toward the upper case in the first direction, and
a space between the partition wall and the energy storage device is filled with a filling member to a position closer to the upper case in the first direction than the joint.

With this configuration, the partition wall protruding beyond the joint between the lower case and the upper case toward the upper case is higher than the joint surface. Therefore, the above space can be filled with the filling member to a position higher than the joint position between the lower case and the upper case.

In the above battery pack,
the partition wall may protrude beyond the energy storage device toward the upper case in
the first direction, and
the space between the partition wall and the energy storage device may be filled with the filling member to a position closer to the upper case in the first direction than the energy storage device.

With this configuration, the partition wall protruding beyond the energy storage device toward the upper case is higher than the energy storage device. Therefore, the above space can be filled with the filling member to the position closer to the upper case in the first direction than the energy storage device.

In the above battery case,
the lower case may include a bottom portion and a side portion, and
the partition wall may extend from the side portion toward the upper case in the first direction.

In this configuration, the partition wall is formed on the side portion of the lower case. Therefore, the volume efficiency of the battery pack can be improved compared to the case where the partition wall is formed on the bottom portion of the lower case.

In the above battery case,
the partition wall may include a first partition wall portion and a second partition wall portion,
the second partition wall portion may extend from a position on the side portion that is closer to the bottom portion in the first direction than the first partition wall portion,
a liquid storage portion may be provided between the second partition wall portion and the side portion, and
a water entry detection device may be mounted in the liquid storage portion.

With this configuration, if water enters the battery pack from outside through the joint, the water is accumulated in the liquid storage portion provided between the second partition wall portion and the side portion of the lower case through between the first partition wall portion and the lower case. Water entry can thus be detected by the water entry detection device. Since the water having entered the battery pack is collected in the liquid storage portion, water entry can be detected early even when the battery pack is only provided with the water entry detection device in a part of the battery pack.

In the above battery case,
the partition wall may be provided with an elastic member on a surface of the partition wall that is located on the upper case side.

In this configuration, the elastic member is provided between the partition wall and the upper case. Accordingly, when an inertial force is applied to the partition wall and the partition wall is deformed enough to hit the upper case, the elastic member functions as a buffer member. Abnormal noise and damage to the partition wall can thus be reduced.

The present disclosure is advantageous in that it provides the battery pack that can be filled with the filling member for restricting lateral displacement of the energy storage device to a position higher than the position of the joint between the lower case and the upper case because the partition wall protruding toward the upper case is higher than the joint between the lower case and the upper case.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a partial cross-sectional view illustrating a schematic configuration of a battery pack according to a first embodiment;

FIG. 2 is a partial cross-sectional view illustrating a schematic configuration of a battery pack according to a second embodiment;

FIG. 3 is a top view of the battery pack according to a third embodiment with the upper cover removed;

FIG. 4 is a B-B cross-sectional view of the battery pack shown in FIG. 3; and

FIG. 5 is a diagram illustrating a case where an elastic member is provided on an upper end surface of a partition wall.

### DETAILED DESCRIPTION OF EMBODIMENTS

### First Embodiment

Hereinafter, a battery pack according to a first embodiment of the present disclosure will be described. Note that the present disclosure is not limited by the present embodiment.

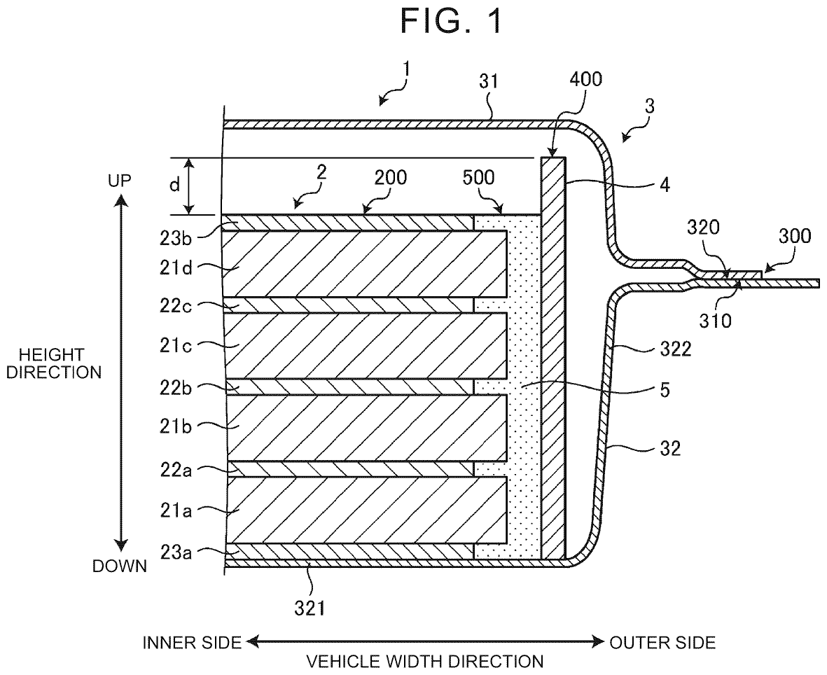

FIG. 1 is a partial cross-sectional view illustrating a schematic configuration of a battery pack 1 according to a first embodiment.

In the first embodiment, the battery pack 1 is mounted on a electrified vehicle and is, for example, a power supply source that supplies electric power to a motor that is a drive source of an electrified vehicle. The battery pack 1 according to the first embodiment includes a case 3 including an upper case 31 and a lower case 32. A battery stack 2, which is an energy storage device, is housed in the case 3.

The battery stack 2 is a stack formed by alternately stacking a plurality of battery modules 21a, 21b, 21c, 21d and a plurality of current-carrying members 22a, 22b, 22c vertically between a lower current-collecting member 23a and an upper current collecting member 23b in a height direction (vertical direction) which is a first direction of the battery pack 1. In the battery pack 1 according to the first embodiment, the height direction is the same as the stacking direction of the plurality of battery modules 21a, 21b, 21c, 21d.

The upper case 31 and the lower case 32 face each other in the height direction. The upper case 31 and the lower case 32 each have a flange-shaped upper-side joint portion 310 and a flange-shaped lower-side joint portion 320 for joining the respective peripheral edges. In the case 3, the case joint 300 is formed by joining the upper-side joint portion 310 and the lower-side joint portion 320. The lower-side joint portion 320 is positioned so as to overlap the battery stack 2 when viewed from the vehicle width direction, which is the second direction perpendicular to the height direction.

The lower case 32 is provided with a plate-shaped partition wall 4 extending upward in the height direction from the bottom portion 321 of the lower case 32 at a predetermined interval from the battery stack 2 so as to surround the battery stack 2. The upper end face 400 of the partition wall 4 protrudes beyond the lower-side joint portion 320 toward the upper case 31 in the height direction. Further, in the battery pack 1 according to the first embodiment, the height of the upper end face (apex) 400 of the partition wall 4 in the height direction is configured to be higher than the height of the upper end face (apex) 200 of the battery stack 2 by a distance d. In the battery pack 1 according to the first embodiment, the upper surface of the upper current collecting member 23b forms the upper end face 200 of the battery stack 2.

A filling member 5 capable of filling the partition wall 4 and the battery stack 2 without gaps is filled between the partition wall 4 and the battery stack 2. In addition, the filling member 5 is filled up to the upper case 31 side in the height direction relative to the lower-side joint portion 320. The upper end surface 500 of the filling member 5 is positioned at substantially the same height as the upper end face 200 of the battery stack 2 in the height direction. The filling member 5 functions as a displacement restricting portion that restricts lateral displacement of the battery stack 2. As the filling member 5, for example, a material which is initially liquid and hardens over time can be used.

Since the filling member 5 is held by the battery stack 2 and the partition wall 4, the filling member 5 can be filled without closing the lid member, and the degree of freedom in the filling operation can be improved. In addition, since the filling member 5 can be visually observed during the filling operation, it is possible to improve the detection efficiency of abnormality such as filling abnormality and improve the quality.

In addition, as in the prior art, the dead space can be reduced as compared with the case where the partition wall 4 is not provided and the filling member 5 is filled before the lid member is closed, and the degree of freedom in adjusting the vehicle height and the battery capacity can be improved.

Further, in the battery pack 1 according to the first embodiment, since the upper end face 400 of the partition wall 4 protrudes beyond the lower-side joint portion 320 toward the upper case 31, even if there is water entry from the case joint 300, it is possible to suppress the water entry to the battery stack 2 by the partition wall 4.

### Second Embodiment

Hereinafter, a second embodiment of the battery pack according to the present disclosure will be described. Note that, in the present embodiment, description of the same configuration as in the first embodiment is omitted as appropriate.

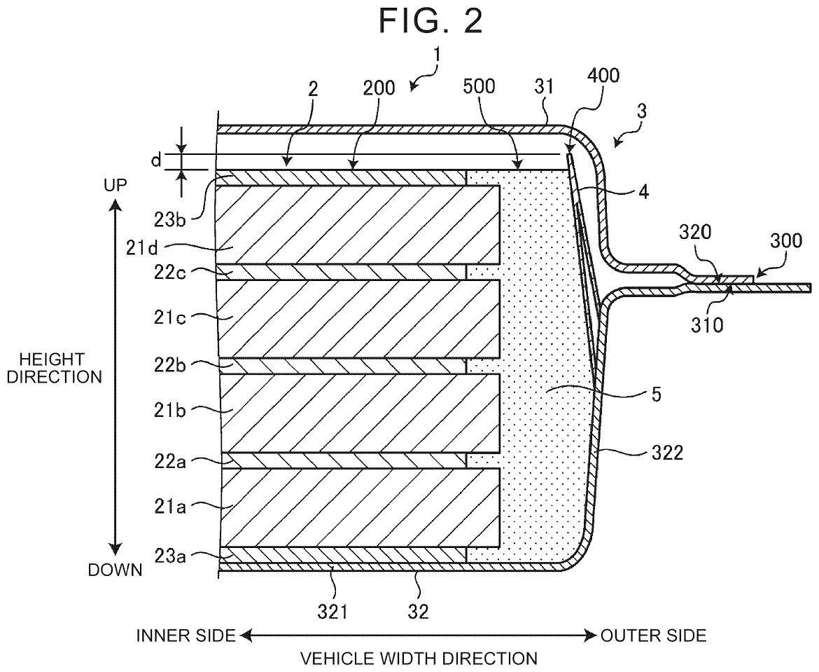

FIG. 2 is a partial cross-sectional view illustrating a schematic configuration of a battery pack 1 according to the second embodiment.

In the battery pack 1 according to the second embodiment, as shown in FIG. 2, the partition wall 4 is provided from the side portion 322 of the lower case 32 toward the upper case 31 in the height direction. Further, the partition wall 4 arranged so as to surround the battery stack 2 is shaped to collapse toward the inside (the inside of the vehicle) in the vehicle width direction upward (vertically upward) in the height direction. In other words, the partition wall 4 is inclined inward in the vehicle width direction with respect to the height direction, and is provided on the side portion 322 of the lower case 32. Note that the partition wall 4 is not limited to being inclined continuously inward in the vehicle width direction, and may be inclined intermittently.

In the battery pack 1 according to the second embodiment, since the partition wall 4 is provided in the side portion 322 of the lower case 32, it is possible to expand the size of the battery stack 2 such as the width as compared with the case where the partition wall 4 is provided in the bottom portion 321 of the lower case 32, and thus it is possible to improve the battery capacity of the battery stack 2.

Further, in the battery pack 1 according to the second embodiment, since the partition wall 4 is provided in the side portion 322 of the lower case 32, it is possible to shorten compared with the case where the partition wall 4 is provided in the bottom portion 321 of the lower case 32, it is possible to reduce the weight of the partition wall 4.

### Third Embodiment

A third embodiment of the battery pack according to the present disclosure will be described below. In the present embodiment, description of the same configuration as that of the second embodiment will be omitted as appropriate.

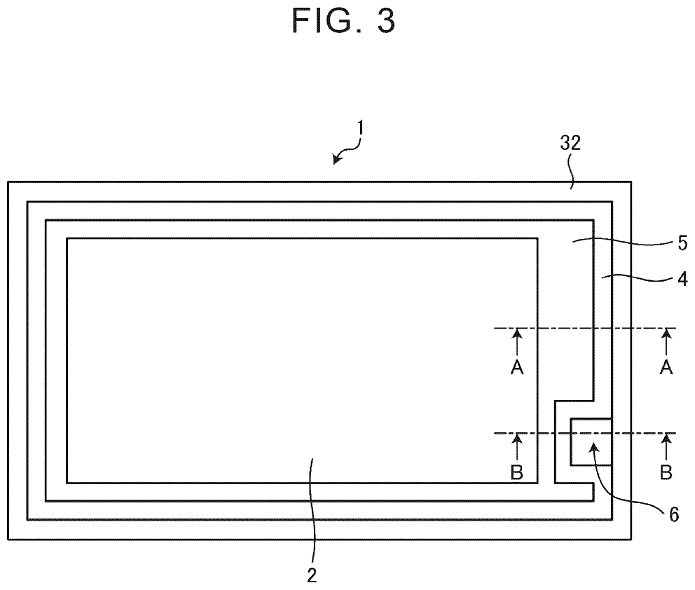

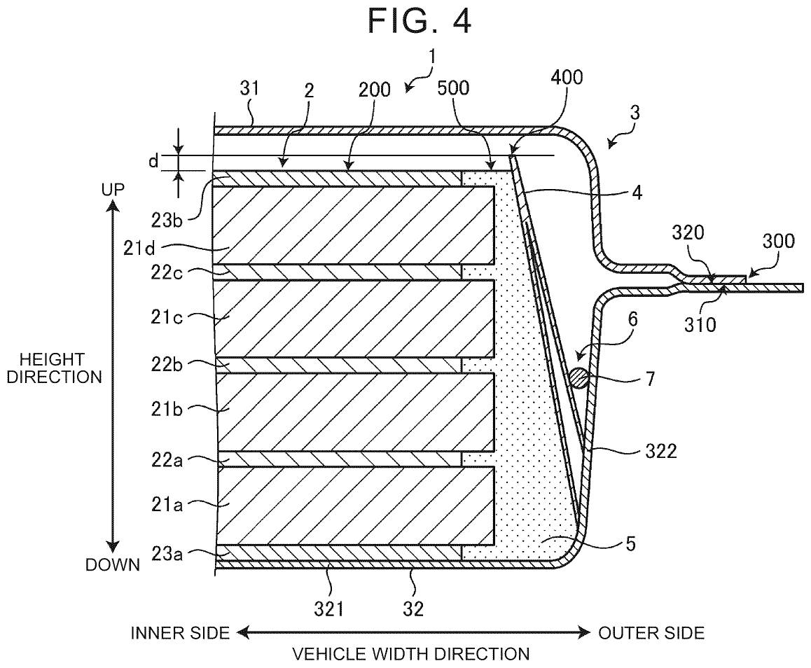

FIG. 3 is a top view of the battery pack 1 according to the third embodiment in a state in which the upper case 31 is removed. FIG. 4 is a B-B cross-sectional view of the battery pack 1 shown in FIG. 3. The A-A cross-sectional view of the battery pack 1 shown in FIG. 3 is the same as that of FIG. 2.

The partition wall 4 is composed of a first partition wall portion which is a portion of the partition wall 4 shown in FIG. 2 and a second partition wall portion which is a portion of the partition wall 4 shown in FIG. 4. The second partition wall portion is provided so as to extend from the bottom portion 321 side in the height direction of the side portion 322 of the lower case 32 with respect to the first partition wall portion. As shown in FIGS. 3 and 4, a liquid storage portion 6 is provided between the second partition wall portion of the partition wall 4 and the side portion 322 of the lower case 32.

In other words, in the battery pack 1 according to the third embodiment, as shown in FIG. 3, a part of the partition wall 4 (second partition wall portion) is recessed inward in the vehicle width direction (inside the battery pack 1) from the other portion (first partition wall portion) to provide the liquid storage portion 6. As shown in FIG. 4, the liquid storage portion 6 has a groove shape that is deeper than other portions (first partition wall portion) where the liquid storage portion 6 as shown in FIG. 2 is not provided. The liquid storage portion 6 is provided with a water entry detection device 7 for detecting the occurrence of water entry in the case 3 from the case joint 300. The water entry detection device 7 detects water entry, for example, by detecting water that has entered the case 3 through the case joint 300 and accumulated in the liquid storage portion 6.

In the battery pack 1 according to the third embodiment, the partition wall 4 in the other portion (first partition wall portion) where the liquid storage portion 6 is not provided as shown in FIG. 2 forms a flow path (trough) for flowing water toward the liquid storage portion 6 by the upper case 31 and the lower case 32. Thus, the water that has entered into the case 3 from the case joint 300 can be easily collected into the liquid storage portion 6 by the flow path, and the water entry detection device 7 can detect the water entry at an early stage. Further, by collecting the water that has entered the case 3 in the liquid storage portion 6, it is possible to detect the water entry early even when the liquid storage portion 6 is mounted at one position in the circumferential direction of the battery stack 2 and the water entry detection device 7 is mounted therein.

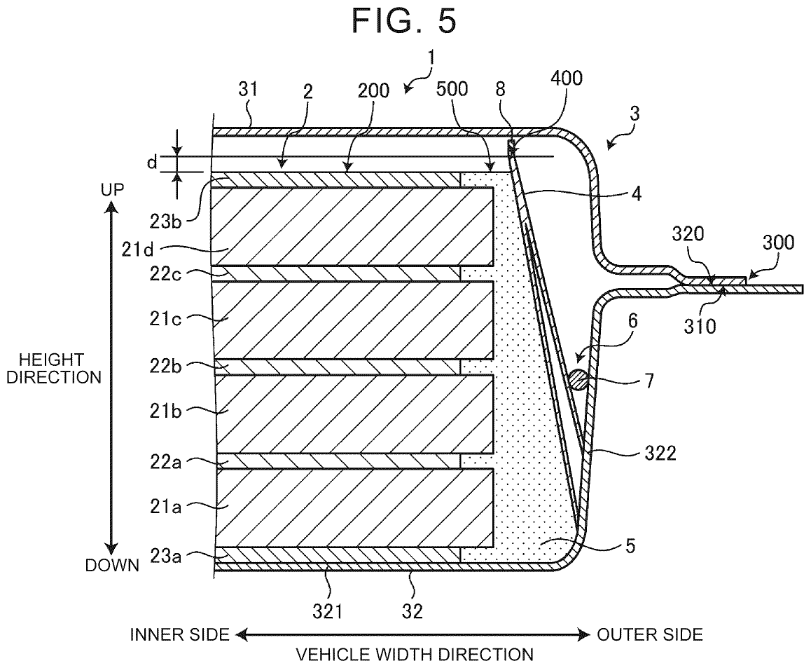

FIG. 5 is a diagram illustrating a case where the elastic member 8 is provided on the upper end face 400 of the partition wall 4.

In the battery pack 1 according to the third embodiment, for example, as shown in FIG. 5, an elastic member 8 made of, for example, rubber or the like may be provided on an upper end face 400 which is a surface of the partition wall 4 located on the upper case 31 side in the height direction. Thus, for example, when the inertial force is transmitted to the partition wall 4 during vehicle running and the partition wall 4 is deformed and collides with the upper case 31, the elastic member 8 functions as a buffer member, and generation of abnormal noise and damage of the partition wall 4 can be suppressed.

What is claimed is:

1. A battery pack including a lower case and an upper case and housing an energy storage device, wherein
the lower case and the upper case face each other in a first direction,
the lower case and the upper case include a joint where the lower case and the upper case are joined together,
the joint is located so as to overlap the energy storage device as viewed in a second direction perpendicular to the first direction,
the lower case includes a partition wall disposed so as to surround the energy storage device,
the partition wall protrudes beyond the joint toward the upper case in the first direction, and
a space between the partition wall and the energy storage device is filled with a filling member to a position closer to the upper case in the first direction than the joint.

2. The battery pack according to claim 1, wherein
the partition wall protrudes beyond the energy storage device toward the upper case in the first direction, and
the space between the partition wall and the energy storage device is filled with the filling member to a position closer to the upper case in the first direction than the energy storage device.

3. The battery pack according to claim 2, wherein
the lower case includes a bottom portion and a side portion, and
the partition wall extends from the side portion toward the upper case in the first direction.

4. The battery pack according to claim 3, wherein
the partition wall includes a first partition wall portion and a second partition wall portion,
the second partition wall portion extends from a position on the side portion that is closer to the bottom portion in the first direction than the first partition wall portion,
a liquid storage portion is provided between the second partition wall portion and the side portion, and
a water entry detection device is mounted in the liquid storage portion.

5. The battery pack according to claim 4, wherein the partition wall is provided with an elastic member on a surface of the partition wall that is located on the upper case side.
